(19) United States
(12) Patent Application Publication
(10) Pub. No.: US 2025/0069277 A1
(43) Pub. Date: Feb. 27, 2025

(54) ELECTRONIC DEVICE PROCESSING IMAGE USING AI ENCODING/DECODING, AND METHOD FOR CONTROLLING SAME

(71) Applicant: SAMSUNG ELECTRONICS CO., LTD., Suwon-si (KR)

(72) Inventor: Kiwon YOO, Suwon-si (KR)

(73) Assignee: SAMSUNG ELECTRONICS CO., LTD., Suwon-si (KR)

(21) Appl. No.: 18/946,460

(22) Filed: Nov. 13, 2024

Related U.S. Application Data
(63) Continuation of application No. PCT/KR2023/006043, filed on May 3, 2023.

(30) Foreign Application Priority Data
Jun. 29, 2022 (KR) 10-2022-0079440

(51) Int. Cl. G06T 9/00; G06N 3/045; H04N 19/436

(52) U.S. Cl. CPC G06T 9/002; G06N 3/045; H04N 19/436

(57) ABSTRACT

Disclosed is an electronic device processing an image using AI encoding. The electronic device comprises: a memory in which a learned first neural network model is stored; a communication interface; and a processor configured to obtain AI decoding information of an external device and context information of the electronic device; identify operation setting information associated with AI encoding based on the AI decoding information of the external device and the context information of the electronic device; input an image into a first neural network model to which the operation setting information is applied to obtain an AI-encoded image; obtain a compressed image by encoding the AI-encoded image; transmit the compressed image and AI encoding information associated with the first neural network model to the external device through the communication interface.

### CROSS-REFERENCES TO RELATED APPLICATIONS

This application is a continuation of International Application No. PCT/KR2023/006043, filed on May 3, 2023, at the Korean Intellectual Property Office, which claims priority from Korean Application No. 10-2022-0079440, filed on Jun. 29, 2022, at the Korean Intellectual Property Office, the disclosures of which are incorporated herein in their entireties.

### BACKGROUND

### 1. Field

The disclosure relates to an electronic device and a method for controlling the same, and more particularly, to an electronic device that processes an image by using AI encoding/decoding, and a method for controlling the same.

### 2. Background

A streaming method is a method by which a server transmits media in real time, and a terminal receives the media and reproduces the media in real time, and media is transmitted while its quality is adaptively changed based on a connection state of a network between a server-a terminal, and a specification of the terminal. For example, if network connection becomes unstable and an available band becomes lower, a service is performed by lowering the image quality, and when the connection becomes stabilized again and a sufficient band is guaranteed, a service is performed by improving the image quality.

Meanwhile, an AI system is a computer system implementing intelligence of a human level, and in the system, a machine can improve its ability by learning and determining by itself, unlike a conventional rule-based system. Recently, an AI system based on a deep neural network (DNN) is greatly overwhelming the performance of a conventional rule-based system, and its use is spreading in all fields. As there is a growing interest in an AI system, researches for improving service quality in image streaming are actively going on.

### SUMMARY

An electronic device configured to process an image by using AI encoding according to an embodiment of the disclosure for achieving the aforementioned purpose includes memory storing a trained first neural network model, a communication interface, and at least one processor configured to obtain AI decoding information of an external device and context information of the electronic device; identify operation setting information associated with AI encoding based on the AI decoding information of the external device and the context information of the electronic device; input an image into a first neural network model to which the operation setting information is applied to obtain an AI-encoded image; obtain a compressed image by encoding the AI-encoded image; transmit the compressed image and AI encoding information associated with the first neural network model to the external device through the communication interface.

An electronic device configured to process an image by using AI decoding according to an embodiment of the disclosure may include memory storing a trained second neural network model, a communication interface, and at least one processor configured to receive a compressed image and AI encoding information through the communication interface, identify operation setting information associated with AI decoding based on the AI encoding information, obtain a reconstructed image by decoding the compressed image, input the reconstructed image into a decoder neural network model to which the operation setting information associated with the AI decoding is applied to obtain an AI-decoded image, and transmit AI decoding information related to the decoder neural network model to an external device.

A method for controlling an electronic device configured to process an image by using AI encoding according to an embodiment of the disclosure may include obtaining AI decoding information of an external device and context information of an electronic device; identifying operation setting information associated with AI encoding based on the AI decoding information of the external device and the context information of the electronic device; obtaining an AI-encoded image by inputting the image into a first neural network model to which the operation setting information associated with the AI encoding is applied; obtaining a compressed image by encoding the AI-encoded image; and transmitting the compressed image and AI encoding information associated with the first neural network model to the external device.

In a non-transitory computer readable medium storing computer instructions that, when executed by a processor of an electronic device, cause the electronic device obtain AI decoding information of an external device and context information of the electronic device; identify operation setting information associated with AI encoding based on the AI decoding information of the external device and the context information of the electronic device; input an image into a first neural network model to which the operation setting information is applied to obtain an AI-encoded image; obtain a compressed image by encoding the AI-encoded image; transmit the compressed image and AI encoding information associated with the first neural network model to the external device through the communication interface.

### BRIEF DESCRIPTION OF THE DRAWINGS

FIG. 1 is a diagram for illustrating a method of processing an image using artificial intelligence (AI) encoding/decoding according to an embodiment of the disclosure;

FIG. 2 is a block diagram illustrating a configuration of an electronic device according to an embodiment of the disclosure;

FIG. 3 illustrates an example of operation setting information of an AI codec Deep Neural Network (DNN) according to an embodiment of the disclosure;

FIG. 4 is a flow chart for illustrating a process of processing an image using AI encoding/decoding according to an embodiment of the disclosure;

FIG. 5 is a diagram for illustrating an example of identifying operation setting information of AI encoding according to an embodiment of the disclosure;

FIG. 6 is a diagram for illustrating an AI encoding process according to an embodiment of the disclosure;

FIG. 7 is an exemplary diagram illustrating a first DNN according to an embodiment of the disclosure;

FIG. 8 is a block diagram illustrating a configuration of an electronic device according to an embodiment of the disclosure;

FIG. 9 is a flow chart for illustrating a process processing an image using AI encoding/decoding and a second electronic device according to an embodiment of the disclosure;

FIG. 10 is a diagram for illustrating an AI decoding process according to an embodiment of the disclosure; and

FIG. 11 is a diagram for illustrating a process of training a first neural network model and a second neural network model in association according to an embodiment of the disclosure.

### DETAILED DISCLOSURE

Hereinafter, the disclosure will be described in detail with reference to the accompanying drawings.

First, terms used in this specification will be described briefly, and then the disclosure will be described in detail.

As terms used in the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Further, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, terms such as “first,” “second” and the like may be used to describe various elements, but the terms are not intended to limit the elements. Such terms are used only to distinguish one element from another element.

In addition, singular expressions include plural expressions, unless defined obviously differently in the context. Further, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Also, the expression “at least one of A or B” should be interpreted to mean any one of “A” or “B” or “A and B.”

In addition, in the disclosure, “a module” or “a part” performs at least one function or operation, and may be implemented as hardware or software, or as a combination of hardware and software. Further, a plurality of “modules” or “parts” may be integrated into at least one module and implemented as at least one processor (not shown), except “modules” or “parts” which need to be implemented as specific hardware.

Hereinafter, an embodiment of the disclosure will be described in detail with reference to the accompanying drawings, such that a person having ordinary knowledge in the technical field to which the disclosure belongs can easily carry out the embodiment. However, the disclosure may be implemented in several different forms, and is not limited to the embodiment described herein. Also, in the drawings, parts that are not related to explanation of the disclosure were omitted, for explaining the disclosure clearly, and throughout the specification, similar components were designated by similar reference numerals.

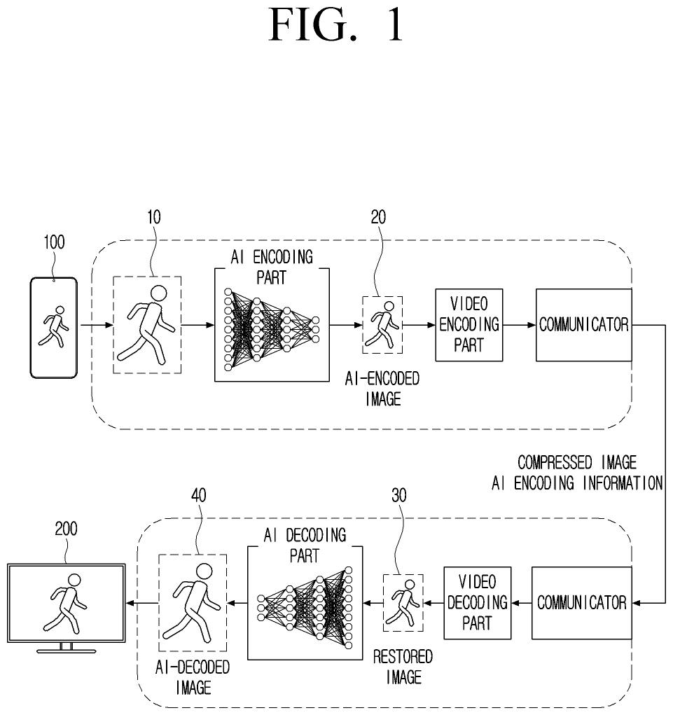

FIG. 1 is a diagram for illustrating a method of processing an image according to AI encoding/decoding according to an embodiment of the disclosure.

For streaming an image of a high definition/a high resolution such as 4K, 8K, etc., through a network, an image encoding technology and an up/down scaling technology that can reduce a required bandwidth of the network are important. For an image encoding, standard codecs such as H.264/265, VP8/9, and AV1 are being used widely, and in the case of over-the-top (OTT) companies, they service 4K images by compressing the images to about 15 Mbps based on H.265. For images to fit different network environments of each user, the images should be compressed in image resolutions and transmission rates in various combinations, and up/down scaling technology is used to process images to fit these environments. For example, when trying to transmit an 8K image in a level of about 15 Mbps, a transmission terminal 100 may perform AI encoding of an image 10 (e.g., down-scaling the resolution to 4K) and obtain an AI-encoded image 20, and perform video encoding of the AI-encoded image 20. Afterwards, the transmission terminal 100 may transmit the compressed image—compressed through the video encoding and information on the AI encoding—to the reception terminal 200 through a communicator.

When the compressed image and the information on the AI encoding are received through the communicator, the reception terminal 200 may perform video decoding of the compressed image and obtain a restored image 30, and perform AI decoding of the restored image 30 (also referred to as reconstructed image or compression-released image) (e.g., up-scaling the resolution to 8K) and obtain an AI-decoded image 40. In related art, when performing up/down scaling, a simple interpolation method such as bi-linear or bi-cubic may be used. However, recently, up/down scaling is performed by using a neural network model, and the image quality felt by consumers is much improved. In particular, AI-based up/down scaling has an advantage of being easily compatible to any kind of compression codec being used, and thus the method can be easily expanded by being applied to a H.265/VP9 standard codec or other codecs that are widely used.

Meanwhile, a neural network model used in AI encoding and decoding, e.g., a DNN model may make determination based on an image resolution and a network state, and the type of a codec, and here, both of a server and a TV can support the maximum performance with AI operation processing using a high performance processor or hardware acceleration, and can use an external power, and thus power consumption does not become a big problem.

However, an AI codec may be utilized in various applications, e.g., screen mirroring, a video conference, remote gaming, etc., and in such applications, both of or either one of a transmission terminal and a reception terminal may be a handheld terminal or a mobile terminal, e.g., a smart device, a mobile projector, a laptop, etc. Characteristics of such devices are that their screen sizes, i.e., resolutions are not big, and their AI performance for video processing may be low, and their remaining power may always need to be managed as they are driven based on batteries. For example, when transmitting an AI-encoded 4K image from a smartphone to a TV, there is a problem that the processor of the smartphone has insufficient performance for processing AI encoding of a 4K image, or even if it can process a 4K image, if the smartphone operates during a video viewing time of a few minutes-scores of minutes, the smartphone may be discharged during viewing due to fast power consumption.

Accordingly, hereinafter, various embodiments related to operations of an improved AI codec that can heighten consumer usability for various applications and terminals wherein the AI codec can be used will be explained.

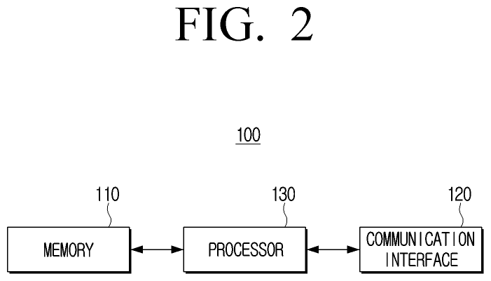

FIG. 2 is a block diagram illustrating a configuration of an electronic device according to an embodiment of the disclosure.

According to FIG. 2, an electronic device 100 includes memory 110, a communication interface 120, and a processor 130.

According to an embodiment, as the electronic device 100 (referred to as a first electronic device hereinafter), any device equipped with an image processing function and/or a display function such as a TV, a smartphone, a tablet PC, a laptop PC, a console, a set-top box, a monitor, a PC, a camera, a camcorder, a large format display (LFD), digital signage, a digital information display (DID), a video wall, etc. can be applied without limitation. According to an embodiment, the first electronic device 100 may function as the transmission terminal 100 in FIG. 1, and may perform AI encoding of an image and transmit the image to an external device, i.e., the reception terminal 200 in FIG. 2.

The memory 110 may be electrically connected with the processor 130 (which may include more than one processors), and may store data necessary for various embodiments of the disclosure. The memory 110 may be implemented in a form of memory embedded in the first electronic device 100, or implemented in a form of memory that can be attached to or detached from the first electronic device 100 according to the usage of stored data. For example, in the case of data for operating the first electronic device 100, the data may be stored in memory embedded in the first electronic device 100, and in the case of data for an extended function of the first electronic device 100, the data may be stored in memory that can be attached to or detached from the first electronic device 100. Meanwhile, in the case of memory embedded in the first electronic device 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the first electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

According to an embodiment, the memory 110 may store a computer program including at least one instruction or instructions for controlling the first electronic device 100.

According to an embodiment, the memory 110 may store an image received from an external device (e.g., a source device), an external storage medium (e.g., a USB), an external server (e.g., a webhard), etc., i.e., an input image. Alternatively, the memory 110 may store an image obtained through a camera (not shown) provided on the first electronic device 100.

According to an embodiment, the memory 110 may store information on a neural network model (or, an artificial intelligence model) including a plurality of layers. Here, the feature of storing information on a neural network model may mean storing various types of information related to the operations of the neural network model, e.g., information on a plurality of layers included in the neural network model, information on parameters (e.g., filter coefficients, biases, etc.) used in each of the plurality of layers, etc. For example, the memory 110 may store information on a first neural network model that was trained to perform AI encoding according to an embodiment. Here, the first neural network model may be implemented as, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), or deep Q-networks, etc., but is not limited thereto. Here, the feature that a neural network model is trained means that a basic neural network model (e.g., an artificial intelligence model including any random parameters) is trained by using a plurality of training data by a learning algorithm, and predefined operation rules or a neural network model set to perform a desired characteristic (or, a purpose) is thereby made. Such learning may be performed through a separate server and/or a system, but the disclosure is not limited thereto, and the learning may be performed at the electronic device. As examples of learning algorithms, there are supervised learning, unsupervised learning, semi-supervised learning, or reinforcement learning, but learning algorithms are not limited to the aforementioned examples.

According to an embodiment, the memory 110 may store various kinds of information necessary for image quality processing, e.g., information, an algorithm, an image quality parameter, etc. for performing at least one of noise reduction, detail enhancement, tone mapping, contrast enhancement, color enhancement, or frame rate conversion. Also, the memory 110 may store a final output image generated by image processing.

According to an embodiment, the memory 110 may be implemented as single memory that stores data generated in various operations according to the disclosure. Meanwhile, according to an embodiment, the memory 110 may also be implemented to include a plurality of memories that respectively store data of different types, or respectively store data generated in different steps.

The communication interface 120 may be a component that performs communication with an external device 200 (referred to as a second electronic device hereinafter). For example, the communication interface 120 may transmit or receive an image signal by a streaming or download method from an external device (e.g., a source device), an external storage medium (e.g., a USB memory), an external server (e.g., a webhard), etc. through communication methods such as AP-based Wi-Fi (Wi-Fi, a wireless LAN network), Bluetooth, Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc.

In the aforementioned embodiment, it was explained that various types of data is stored in the external memory 110 of the processor 130, but at least some of the aforementioned data may be stored in internal memory of the processor 130 according to an implementation example of at least one of the first electronic device 100 or the processor 130.

The at least one processor 130 (referred to as the processor hereinafter) is electrically connected with the memory 110 and controls the overall operations of the first electronic device 100. The at least one processor 130 may consist of one or a plurality of processors. Here, the one or plurality of processors may be implemented as at least one software or at least one hardware, or a combination of at least one software and at least one hardware. According to an embodiment, software or hardware logic corresponding to the at least one processor may be implemented in one chip. According to an embodiment, software or hardware logic corresponding to some of the plurality of processors may be implemented in one chip, and software or hardware logic corresponding to the remaining processors may be implemented in another chip.

Specifically, the processor 130 may perform operations of the first electronic device 100 according to various embodiments of the disclosure by executing the at least one instruction stored in the memory 110.

According to an embodiment, the processor 130 may be implemented as a digital signal processor (DSP) processing digital image signals, a microprocessor, a graphics processing unit (GPU), an artificial intelligence (AI) processor, a neural processing unit (NPU), and a time controller (TCON). However, the disclosure is not limited thereto, and the processor 130 may include one or more of a central processing unit (CPU), a micro controller unit (MCU), a micro processing unit (MPU), a controller, an application processor (AP), or a communication processor (CP), and an ARM processor, or may be defined by the terms. Also, the processor 130 may be implemented as a system on chip (SoC) having a processing algorithm stored therein or large scale integration (LSI), or implemented in the form of an application specific integrated circuit (ASIC) or a field programmable gate array (FPGA).

Also, the processor 130 for executing a neural network model according to an embodiment may be implemented through a combination of a generic-purpose processor such as a CPU, an AP, a digital signal processor (DSP), etc., a graphic-dedicated processor such as a GPU and a vision processing unit (VPU), or an artificial intelligence-dedicated processor such as a neural processing unit (NPU) and software. The processor 130 may perform control to process input data according to the predefined operation rules or the neural network model stored in the memory 110. Alternatively, in case the processor 130 is a dedicated processor (or an artificial intelligence-dedicated processor), the processor 130 may be designed as a hardware structure specified for processing of a specific neural network model. For example, hardware specified for processing of a specific neural network model may be designed as a hardware chip such as an ASIC, an FPGA, etc. In case the processor 130 is implemented as a dedicated processor, the processor 130 may be implemented to include memory for implementing the embodiments of the disclosure, or implemented to include a memory processing function for using external memory.

According to an embodiment, the processor 130 may obtain an AI-encoded image by inputting an image (e.g., an input image) into the trained first neural network model, and encode the AI-encoded image (or perform first encoding or video encoding) and obtain a compressed image (or an encoded image). Here, the first neural network model is a model that was trained to obtain AI-encoded images, and may be implemented as a first DNN according to an embodiment, but is not limited thereto. However, hereinafter, a case wherein the first neural network model is implemented as the first DNN will be assumed, for the convenience of explanation.

An encoding (or the first encoding or video encoding) process may include a process of generating prediction data by predicting a compressed image, a process of generating residual data corresponding to a difference between the compressed image and the prediction data, a process of transforming the residual data which is a spatial area component into a frequency area component, a process of quantizing the residual data transformed into a frequency area component, and a process of performing entropy encoding of the quantized residual data, etc. Such an encoding process may be implemented through one of image compression methods using frequency conversion such as MPEG-2, H.264 Advanced Video Coding (AVC), MPEG-4, High Efficiency Video Coding (HEVC), VC-1, VP8, VP9, and AOMedia Video 1 (AV1), etc.

Then, the processor 130 may transmit the compressed image and AI encoding information related to the first neural network model to the second electronic device 200, e.g., an AI decoding device through the communication interface 120. The AI encoding information may be transmitted together with the image data of the compressed image. Alternatively, depending on implementation examples, the AI encoding information may be transmitted while being distinguished from the image data in a form of a frame or a packet. The image data and the AI encoding information may be transmitted through the same network or different networks.

Here, the AI encoding information may include information on whether AI encoding processing was performed and operation setting information related to the AI encoding (referred to as AI encoding operation setting information or first DNN operation setting information hereinafter). For example, the AI encoding operation setting information may include at least one of information on the number of layers of the first neural network model (or the first DNN), information on the number of channels for each layer, information on a filter size, information on stride, information on pulling, or information on a parameter.

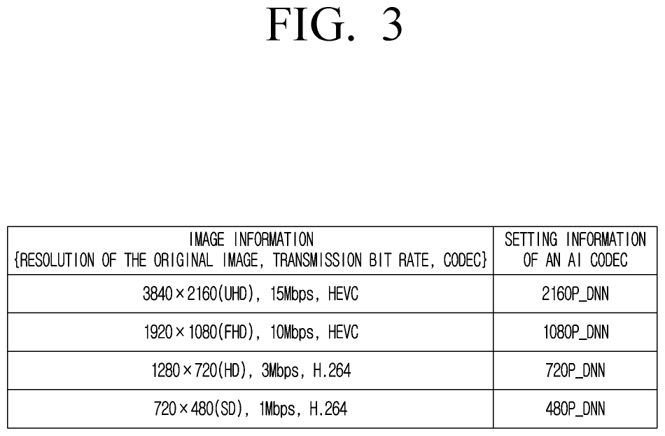

According to an embodiment, the first neural network model (also known as encoder neural network), e.g., the first DNN may be trained based on an image size, a network state, the type of a codec, etc. in a transmission terminal/a reception terminal. Also, the first DNN may be trained in association with not only an encoding process, but also a decoding process of the second neural network model (also known as decoder neural network) used in the AI decoding device. For example, the first DNN may be trained in mutual association to minimize data loss and degradation of visual recognition, etc. that may be generated in downscaling/upscaling and compression/restoration in an encoding process and a decoding process. FIG. 3 illustrates an example of operation setting information of an AI codec DNN according to an embodiment of the disclosure. For example, if an input image is of ultra-high definition (UHD) and the bit rate is 15 Mbps, 2160P_DNN operation setting information may be used in AI encoding, and HEVC may be used in video encoding/decoding. Alternatively, if an image is of HD and the bit rate is 3 Mbps, 720P_DNN operation setting information may be used in AI encoding, and H.264 may be used in video encoding/decoding.

According to an embodiment, the processor 130 may identify operation setting information of the first neural network model based on context information of the first electronic device 100 and AI decoding information of an external device. Here, the feature of identifying the operation setting information of the first neural network model may have the same meaning as identifying the first neural network model corresponding to the context information of the first electronic device 100 and the AI decoding information of the external device.

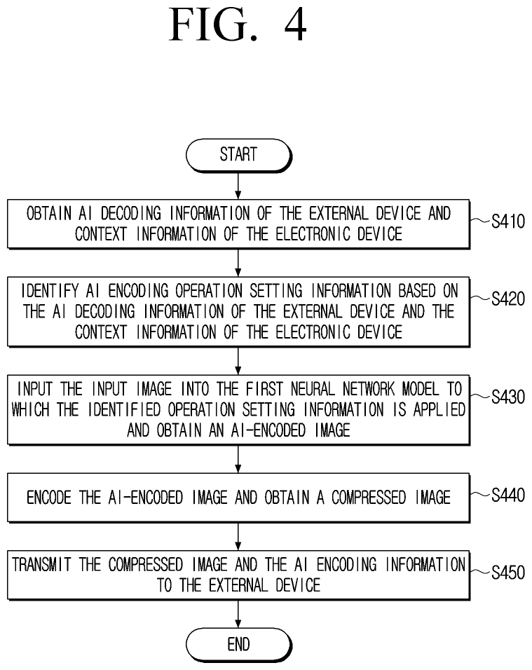

FIG. 4 is a flow chart for illustrating an operation of a first electronic device according to an embodiment of the disclosure.

According to FIG. 4, the processor 130 obtains AI decoding information of an external device and context information of the first electronic device 100 in operation S410. Here, the context information of the first electronic device 100 may include at least one of performance information or state information of the first electronic device 100.

The performance of the first electronic device 100 may be related to the processing performance of a processor or dedicated hardware that processes AI encoding. According to an embodiment, the processing performance may be the current processing performance, and the current processing performance may be lower than the maximum performance in case the device drives several applications simultaneously, and may be performance of guaranteeing real time processing at the time of simultaneous processing for real time processing for image reproduction. For example, the performance information of the first electronic device 100 may include at least one of information on an image size that can be processed, information on a scanning rate of the display (not shown), information on the number of pixels of the display (not shown), or information on a parameter of the first neural network model.

The state of the first electronic device 100 may be related to the current power state. For example, the state information of the first electronic device 100 may include at least one of information on the ratio of the remaining power (the ratio of the remaining capacity compared to the entire capacity of power), information on the capacity of the remaining power, or information on available time. For example, in case the first electronic device 100 uses an external power, it may be identified that the remaining capacity is the same as the entire total capacity of the power.

Meanwhile, the AI decoding information of the external device may include operation setting information of the second neural network model (decoder neural network or the second DNN) used in AI decoding in the second electronic device 200, i.e., AI decoding operation setting information. Here, the AI decoding operation setting information may include at least one of information on the number of layers of the second neural network model, information on the number of channels for each layer, information on a filter size, information on stride, information on pulling, or information on a parameter.

Then, the processor 130 may identify AI encoding operation setting information based on the AI decoding information of the second electronic device 200 and the context information of the first electronic device 100 in operation S420. Here, the AI encoding operation setting information is operation setting information of the first neural network model, and may include at least one of information on the number of layers of the first neural network model, information on the number of channels for each layer, information on a filter size, information on stride, information on pulling, or information on a parameter.

Then, the processor 130 may input an image into the first neural network model to which the obtained operation setting information is applied, and obtain an AI-encoded image in operation S430. Here, the first neural network model is a model that was trained to perform AI downscaling of an image, and may be implemented as a deep neural network (DNN), but is not necessarily limited thereto.

Then, the processor 130 may encode the AI-encoded image and obtain a compressed image in operation S440, and transmit the obtained compressed image and the AI encoding information to the second electronic device 200 in operation S450. For example, the processor 130 may obtain a compressed image by converting the AI-encoded image into a compressed image in a binary data format. For example, compression of an image may be performed according to a general video compression method, e.g., H.264, HEVC, VP9, AV1, VVC, etc.

According to an embodiment, the first neural network model may be trained in association with the second neural network model provided in the second electronic device 200, i.e., a model that performs AI upscaling. That is, the first neural network model may be trained in association with the operation setting information of the second neural network model. This is because, in case a neural network model for AI downscaling and a neural network model for AI upscaling are separately trained, a difference between an image which is a subject for AI encoding and an image restored through AI decoding in the external device may become big.

According to an embodiment, for maintaining such a relation of association in an AI encoding process of the first electronic device 100 and an AI decoding process of the second electronic device 200, AI decoding information and AI encoding information may be used. Accordingly, the AI encoding information obtained through the AI encoding process may include information on an upscaling target, and in the AI decoding process, an image may be upscaled according to the information on the upscaling target that is identified based on the AI encoding information. Here, the AI encoding information may include whether AI encoding processing of the image will be performed, and a target upscaling resolution.

According to an embodiment, the neural network model for AI downscaling and the neural network model for AI upscaling may be implemented as deep neural networks (DNNs). For example, the first DNN for AI downscaling and the second DNN for AI upscaling are trained in association through sharing of loss information under a predetermined target, and thus the first electronic device 100, i.e., the AI encoding device may provide target information used when the first DNN and the second DNN were trained in association to the second electronic device 200, i.e., the AI decoding device, and the external device, i.e., the AI decoding device may perform AI upscaling of the image to the target resolution based on the provided target information.

According to an embodiment, the processor 130 may identify the first operation setting information based on the AI decoding information received from the second electronic device 200, and identify the second operation setting information based on the context information of the electronic device. Afterwards, the processor 130 may input an image into the first neural network model to which operation setting information having relatively lower processing performance is applied from among the first operation setting information and the second operation setting information. According to an embodiment, the processor 130 may identify the first neural network model to which the first operation setting information is applied based on the AI decoding information of the external device, and identify the first neural network model to which the second operation setting information is applied based on the context information of the first electronic device 100. Here, the AI decoding information may include the operation setting information of the second neural network model used in AI decoding in the external device.

According to an embodiment, the processor 130 may identify priorities regarding a plurality of information included in the AI decoding information of the second electronic device 200 and the context information of the first electronic device 100, and identify weights for each of the plurality of information based on the priorities, and obtain operation setting information related to the AI encoding (referred to as AI encoding operation setting information hereinafter) based on the identified weights.

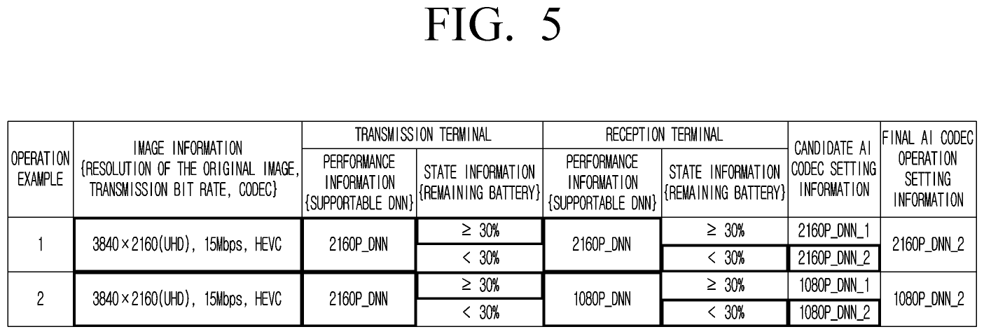

FIG. 5 is a diagram for illustrating an example of identifying operation setting information of AI encoding according to an embodiment of the disclosure.

According to an embodiment, the processor 130 may identify AI encoding operation setting information based on image information, performance information and state information of the transmission terminal (i.e., the first electronic device 100), and performance information and state information of the reception terminal (i.e., the external device). For example, the processor 130 may identify AI encoding DNN operation setting information of an input image based on at least one information among image/network/codec information, terminal state information, and AI decoding information.

In FIG. 5, the performance information of a terminal was assumed as image size information that can be processed, and for the state information, the boundary value for distinguishing the ratio of the remaining power was set as 30%, for the convenience of explanation.

In the first operation example, when the image/network/code information is UHD/15 Mbps/HEVC, and the current performance/state information of the transmission terminal is 2160P_DNN/67%, and the current performance/state information of the reception terminal is 2160P_DNN/18%, 2160P_DNN_2 of which complexity is low may be identified for use for low power among 2160P_DNN candidates.

In the second operation example, the current performance of the reception terminal became lower as 1080P_DNN, and here, the candidates may become 1080P_DNN corresponding to the reception terminal, and 1080P_DNN_2 for use for lower power may be identified among them.

Here, reduction of operation complexity of a DNN is possible through reduction of the number of convolution operations which are basic operations of the DNN, and reduction of convolution complexity, and the operation complexity can be reduced by using at least one of change of the number of layers, change of the number of channels inside layers, change of a filter size, change of stride, or change of quantization strength.

According to an embodiment, in case the states of the transmission terminal/the reception terminal are different, usability can be preferentially considered by identifying operation setting information to suit the terminal in a relatively lower state.

According to an embodiment, it is also possible to select priorities of processing for at least one of an AI encoding process/an AI decoding process or prioritization of the image quality according to the terminal state, prioritization of the use time, prioritization of a specific terminal, detailed setting/subdivision of state boundary values, optimization of the image quality/the battery, etc. as standards for determination. Such standards for determination may be selected according to a user instruction, but is not necessarily limited thereto, and it is also possible that the standards are automatically set by the context, the use history information of the user, etc. of at least one of the first electronic device 100 or the external device.

According to an embodiment, the neural network model according to the performance information and the state information of the terminal may be determined by associating the AI encoding of the transmission terminal and the AI decoding of the reception terminal as illustrated in FIG. 5. However, according to an embodiment, the neural network model according to the performance information and the state information of the terminal may be separately determined in consideration of the performance and the states of each of the transmission terminal and the reception terminal. For example, a case wherein the reception terminal is a smartphone and supports 1080P_DNN at the maximum and of which battery amount is smaller than 30%, and the transmission terminal is a TV in a living room and supports 2160P_DNN at the maximum and uses an external power is assumed. In this case, the transmission terminal may use 1080P_DNN_2 for AI encoding, and the reception terminal may use 2160P_DNN_1 for AI decoding. However, for such an operation, training regarding an asymmetrical DNN combination of AI encoding and AI decoding and management of parameters in this regard may be required.

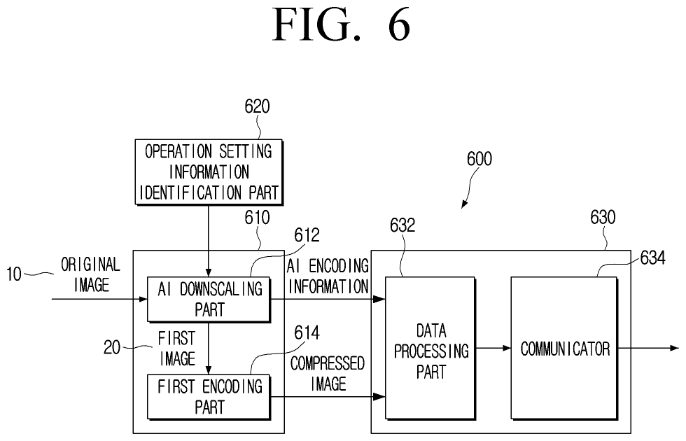

FIG. 6 is a diagram for illustrating an AI encoding method according to an embodiment of the disclosure.

According to an embodiment, the first electronic device 100 may be implemented as the AI encoding device 600 illustrated in FIG. 6.

Referring to FIG. 6, the AI encoding device 600 may include an encoding module 610, an operation setting information identification module 620, and a transmitter 630. The encoding module 610 may include an AI downscaling module 612 and a first encoding module 614. The transmitter 630 may include a data processing module 632 and a communicator 634.

FIG. 6 illustrates the encoding module 610, the operation setting information identification module 620, and the transmitter 630 as separate devices, but the encoding module 610, the operation setting information identification module 620, and the transmitter 630 may be implemented through one processor. In this case, the encoding module 610, the operation setting information identification module 620, and the transmitter 630 may be implemented through a dedicated processor, or implemented through a combination of a generic-purpose processor such as an AP or a CPU, and a GPU and S/W. Also, in the case of a dedicated processor, it may be implemented to include memory for implementing the embodiments of the disclosure, or implemented to include a memory processing module for using external memory. Also, the encoding module 610, the operation setting information identification module 620, and the transmitter 630 may consist of a plurality of processors. In this case, the encoding module 610, the operation setting information identification module 620, and the transmitter 630 may be implemented through a combination of dedicated processors, or implemented through a combination of a plurality of generic-purpose processors such as an AP or a CPU, and a GPU and S/W. The AI downscaling module 612 and the first encoding module 614 may also be respectively implemented as different processors.

The encoding module 610 performs AI downscaling of an image 10 and the first encoding (e.g., video encoding) of the downscaled image (referred to as the first image hereinafter) 2000 (e.g., AI-encoded image 20), and transmits AI encoding information and image data of the compressed image to the transmitter 630. The transmitter 630 transmits the AI encoding information and the image data of the compressed image to the AI decoding device 1600.

The image data includes data that was obtained as a result of the first encoding of the first image 2000. The image data may include data obtained based on pixel values within the first image 2000, e.g., residual data which is a difference between the first image 2000 and the prediction data of the first image 2000. Also, the image data includes information that was used in the first encoding process of the first image 2000. For example, the image data may include information on the prediction mode used in performing the first encoding of the first image 2000, movement information, and information related to a quantization parameter used in performing the first encoding of the first image 2000, etc.

The AI encoding information includes information that enables the AI upscaling module included in the AI decoding device 200 to perform AI upscaling of an image to an upscaling target corresponding to a downscaling target of the first DNN for AI downscaling. According to an embodiment, the AI encoding information may include information on a difference between the image 10 and the first image 2000. Also, the AI encoding information may include information related to the first image. The information related to the first image may include information on at least one of the resolution of the first image 2000, the bit rate of the image data obtained as a result of the first encoding of the first image 2000, or the type of the codec used in the first encoding of the first image 2000.

Also, according to an embodiment, the AI encoding information may include DNN operation setting information that can be set in the second DNN used in upscaling in the AI decoding device 100.

The AI downscaling module 612 may obtain the first image that was AI downscaled from the image 10 through the first DNN. The AI downscaling module 612 may determine a downscaling target of the image 10 based on the AI decoding information.

For obtaining the first image 2000 corresponding to the downscaling target, the operation setting information identification module 620 may identify a plurality of DNN operation setting operation that can be set in the first DNN based on the AI decoding information. The AI downscaling module 612 performs AI downscaling of an image through the first DNN set with the DNN operation setting information identified in the operation setting information identification module 620. Each of the plurality of DNN operation setting information may have been trained to obtain the first image 2000 of a predetermined resolution and/or predetermined image quality. For example, any one DNN operation setting information among the plurality of DNN operation setting information may include information for obtaining the first image 2000 of a resolution smaller than the resolution of the image by ½0 times, e.g., the first image 2000 of 2K (2048*1080) that is smaller than the image 10 of 4K (4096*2160) by ½ times, and another DNN operation setting information may include information for obtaining the first image 2000 of a resolution smaller than the resolution of the image 10 by ¼ times, e.g., the first image 2000 of 2K (2048*1080) that is smaller than the image 10 of 8K (8192*4320) by ¼ times.

Depending on implementation examples, in case information constituting the DNN operation setting information (e.g., the number of convolution layers, the number of filter kernels of each convolution layer, parameters of each filter kernel, etc.) is stored in a form of a lookup table, the AI downscaling module 612 may obtain DNN operation setting information by combining some selected values among the lookup table values based on the AI decoding information, and may perform AI downscaling of the image 10 by using the obtained DNN operation setting information.

The AI downscaling module 612 may set the first DNN with the DNN operation setting information determined for AI downscaling of an image, and obtain the first image 2000 of a predetermined resolution and/or predetermined image quality through the first DNN. When the DNN operation setting information for AI downscaling of an image among the plurality of DNN operation setting information is obtained, each layer inside the first DNN may process input data based on information included in the DNN operation setting information.

According to an embodiment, the AI downscaling module 612 may determine a downscaling target based on at least one of the compression rate (e.g., a difference between the resolutions of the image 10 and the first image 2000, the target bit rate), the compression quality (e.g., the bit rate type), the compression history information, or the type of the image 10.

According to an embodiment, the AI downscaling module 612 may determine a downscaling target based on the AI decoding information.

According to an embodiment, the AI downscaling module 612 may determine a downscaling target based on the compression history information and the AI decoding information stored in the AI encoding device 600. For example, according to the compression history information that can be used by the AI encoding device 600, candidate encoding qualities or candidate compression rates, etc. preferred by a user may be determined, and the ultimate encoding quality or the ultimate compression rate, etc. may be determined based on the AI decoding information.

According to an embodiment, the AI downscaling module 612 may determine a downscaling target based on the resolution of the image 10, the type (e.g., the format of the file), and the AI decoding information.

According to an embodiment, in case the image 10 consists of a plurality of frames, the AI downscaling module 612 may independently determine downscaling targets for each frame of a predetermined number, or determine a common downscaling target for the entire frames.

According to an embodiment, the AI downscaling module 612 may divide frames constituting the image 10 into groups of a predetermined number, and independently determine downscaling targets for each group. The same downscaling target or different downscaling targets may be determined for each group. The number of frames included in the groups may be the same or different for each group.

According to an embodiment, the AI downscaling module 612 may independently determine downscaling targets for each frame constituting the image 10. The same downscaling target or different downscaling targets may be determined for each frame.

Hereinafter, an exemplary structure of the first DNN 300 which becomes the basis for AI downscaling will be explained.

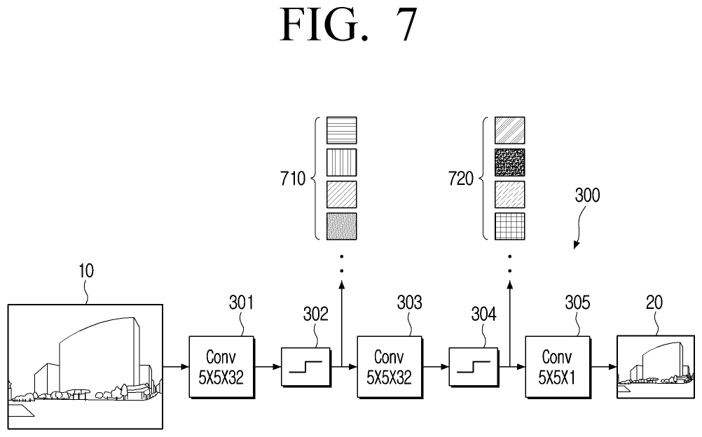

FIG. 7 is an exemplary diagram illustrating the first DNN 300 for AI downscaling of the image 10.

As illustrated in FIG. 7, the image 10 is input into the first convolution layer 301. The first convolution layer 301 performs convolution processing for the image 10 by using N, e.g., 32 filter kernels in a size of N×N, e.g., 5×5. The 32 feature maps generated as a result of convolution processing are input into the first activation layer 302. The first activation layer 302 may grant a non-linear feature to the 32 feature maps.

The first activation layer 302 determines whether to transmit the sample values of the feature maps output from the first convolution layer 302 to the second convolution layer 303. For example, some sample values among the sample values of the feature maps are activated by the first activation layer 302 and transmitted to the second convolution layer 303, and some sample values are inactivated by the first activation layer 302 and are not transmitted to the second convolution layer 303. Information indicated by the feature maps output from the first convolution layer 301 is emphasized by the first activation layer 302.

An output 710 of the first activation layer 302 is input into the second convolution layer 303. The second convolution layer 303 performs convolution processing for input data by using 32 filter kernels in a size of 5×5. The 32 feature maps output as a result of the convolution processing may be input into the second activation layer 304, and the second activation layer 304 may grant a non-linear feature to the 32 feature maps.

An output 720 of the second activation layer 304 is input into the third convolution layer 305. The third convolution layer 305 performs convolution processing for input data by using one filter kernel in a size of 5×5. One image may be output from the third convolution layer 305 as a result of the convolution processing. The third convolution layer 305 obtains one output by using one filter kernel as a layer for outputting a final image. According to an embodiment of the disclosure, the third convolution layer 305 may output the first image 2000 through a convolution operation result.

There may be a plurality of DNN operation setting information indicating the number of the filter kernels, the parameters of the filter kernels, etc. of the first convolution layer 301, the second convolution layer 303, and the third convolution layer 305 of the first DNN 300, and the plurality of DNN operation setting information should be associated with the plurality of DNN operation setting information of the second DNN. Association between the plurality of DNN operation setting information of the first DNN and the plurality of DNN operation setting information of the second DNN may be implemented through associative training of the first DNN and the second DNN.

FIG. 7 illustrates that the first DNN 300 includes three convolution layers 301, 303, 305 and two activation layers 302, 304, but this is merely an example, and depending on implementation examples, the number of the convolution layers and the activation layers may be changed in various ways. Also, depending on implementation examples, the first DNN 300 may be implemented through a recurrent neural network (RNN). This case means that the CNN structure of the first DNN 300 according to an embodiment of the disclosure is changed to an RNN structure.

According to an embodiment, the AI downscaling module 612 may include at least one ALU for a convolution operation and an operation of an activation layer. The ALU may be implemented as a processor. For a convolution operation, the ALU may include a multiplier that performs multiplication operations between sample values of feature maps output from the image 10 or the previous layer and sample values of filter kernels, and an adder that adds the result values of the multiplications. Also, for an operation of an activation layer, the ALU may include a multiplier that multiplies a weight used in a predetermined Sigmoid function, a Tanh function, or a ReLU function, etc. with an input sample value, and a comparator that compares the result of the multiplication and a predetermined value, and determines whether to transmit the input sample value to the next layer.

Referring to FIG. 7 again, the first encoding module 614 that received the first image 2000 from the AI downscaling module 612 may perform the first encoding of the first image 2000, and may thereby reduce the amount of information included by the first image 2000. As a result of the first encoding by the first encoding module 614, image data corresponding to the first image 2000 may be obtained.

The data processing module 632 performs processing such that at least one of the AI encoding information or the image data of a compressed image can be transmitted in a predetermined form. For example, in case the AI encoding information and the image data should be transmitted in a form of a bitstream, the data processing module 632 processes the AI encoding information in a form of a bitstream, and transmits the AI encoding information in a form of one bitstream and the image data through the communicator 634. As an example, the data processing module 632 processes the AI encoding information in a form of a bitstream, and transmits each of the bitstream corresponding to the AI encoding information and the bitstream corresponding to the image data through the communicator 634. As an example, the data processing module 632 processes the AI encoding information as a frame or a packet, and transmits the image data in a form of a bitstream, and the AI encoding information in a form of a frame or a packet through the communicator 634.

The communicator 634 may transmit the image data and the AI encoding information through the same kind of network or different kinds of networks.

According to an embodiment, the AI encoding information obtained as a result of processing by the data processing module 632 may be stored in a data storage medium including a magnetic medium such as a hard disk, a floppy disk, and a magnetic tape, an optical recording medium such as a CD-ROM and a DVD, a magneto-optical medium such as a floptical disk, etc.

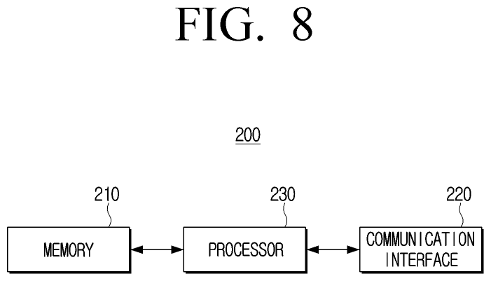

FIG. 8 is a block diagram illustrating a configuration of an electronic device according to an embodiment of the disclosure.

According to FIG. 8, the electronic device 200 includes memory 210, a communication interface 220, and a processor 230.

According to an embodiment of the disclosure, the electronic device 200 (referred to as the second electronic device hereinafter) may be implemented as a TV, but is not limited thereto, and any device equipped with an image processing function and/or a display function such as a smartphone, a tablet PC, a laptop PC, a consol, a set-top, a monitor, a PC, a camera, a camcorder, a large format display (LFD), digital signage, a digital information display (DID), a video wall, etc. can be applied without limitation. According to an embodiment, the second electronic device 200 may function as the reception device, and may perform AI decoding of an AI-encoded image received from the first electronic device 100 illustrated in FIG. 2, and display the image.

As the implementation forms of the memory 210, the communication interface 220, and the processor 230 are identical/similar to the implementation forms illustrated in FIG. 2, detailed explanation will be omitted.

According to an embodiment, the memory 210 may store information on a neural network model (or an artificial intelligence model) including a plurality of layers. Here, the feature of storing information on a neural network model may mean storing various types of information related to the operations of the neural network model, e.g., information on a plurality of layers included in the neural network model, information on parameters (e.g., filter coefficients, biases, etc.) used in each of the plurality of layers, etc. For example, the memory 210 may store information on a second neural network model that was trained to perform AI decoding according to an embodiment. Here, the second neural network model may be implemented as, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), or deep Q-networks, etc., but is not limited thereto.

According to an embodiment, the memory 210 may store various types of information needed for image quality processing, e.g., information, an algorithm, an image quality parameter, etc. for performing at least one of noise reduction, detail enhancement, tone mapping, contrast enhancement, color enhancement, or frame rate conversion. Also, the memory 210 may store an AI-encoded image received from the first electronic device 100 and/or a final output image generated by image processing.

The processor 230 obtains an output image by performing image processing of an input image. Here, an input image or an output image may include a still image, a plurality of consecutive still images (or frames), or a video. The image processing may be digital image processing including at least one of image enhancement, image restoration, image transformation, image analysis, image understanding, or image compression. According to an embodiment, in case an input image is a compressed image that went through AI encoding, the processor 230 may release the compression by performing decoding and AI decoding of the compressed image, and then perform image processing. According to an embodiment, the processor 230 may perform image processing of an input image by using the neural network model. For example, for using the neural network model, the processor 230 may load information related to the neural network model stored in the memory 210, e.g., external memory such as DRAM, and use the information.

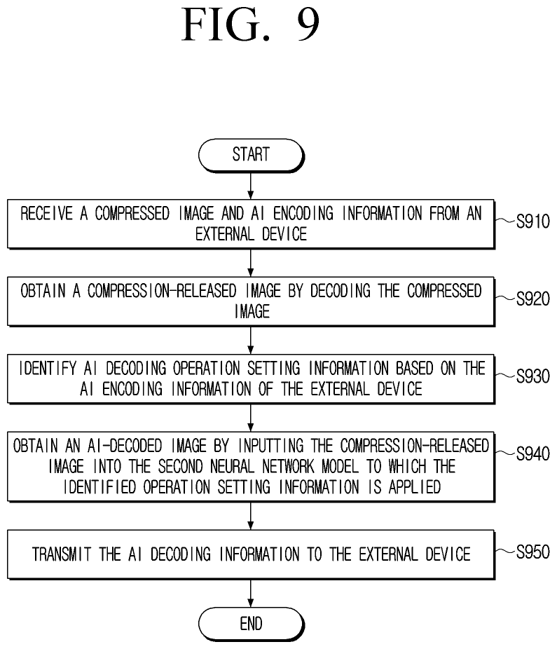

FIG. 9 is a flow chart for illustrating an operation of a second electronic device according to an embodiment of the disclosure.

The processor 230 may receive a compressed image and AI encoding information through the communication interface 220 in operation S910. For example, the processor 230 may receive a compressed image and AI encoding information from the first electronic device 100 illustrated in FIG. 2.

Then, the processor 230 may perform decoding (or the first decoding or video decoding) of the compressed image, and obtain a compression-released image (or a decoded image) in operation S920. The decoding (or the first decoding or video decoding) process may include a process of performing entropy decoding of image data and generating quantized residual data, a process of inverse-quantizing the quantized residual data, a process of converting the residual data which is a frequency area component into a spatial area component, a process of generating prediction data, and a process of restoring the compression-released image by using the prediction data and the residual data, etc. Such a decoding process (or the first decoding) may be implemented through an image restoration method corresponding to one of image compression methods using frequency conversion such as MPEG-2, H.264, MPEG-4, HEVC, VC-1, VP8, VP9, and AV1, etc. used in the encoding process (or the first encoding) in the external first electronic device 100.

Then, the processor 230 may identify AI decoding operation setting information based on the received AI encoding information in operation S930. Here, the AI decoding operation setting information may include at least one of information on the number of layers of the second neural network model, information on the number of channels for each layer, information on a filter size, information on stride, information on pulling, or information on a parameter. According to an embodiment, it is also possible that the processor 230 identifies the AI decoding operation setting information in consideration of not only the AI encoding information but also the context information of the second electronic device 200. As the context information of the second electronic device 200 is identical/similar to the context information of the first electronic device 100 explained in FIG. 2, detailed explanation will be omitted.

Then, the processor 230 may obtain an AI-decoded image by inputting the compression-released image into the second neural network model (e.g., the second DNN) to which the identified AI decoding operation setting information is applied in operation S940.

Afterwards, the processor 230 may transmit the AI decoding information related to the second neural network model to an external device, e.g., the first electronic device 100 in FIG. 2 through the communication interface 220.

According to an embodiment, the processor 230 may identify priorities regarding a plurality of information included in the AI encoding information of the first electronic device 100, and identify weights for each of the plurality of information based on the priorities. Then, the processor 230 may identify AI decoding operation setting information based on the identified weights. Afterwards, the processor 230 may input the compression-released image into the second neural network model to which the identified AI decoding operation setting information is applied.

According to an embodiment, the processor 230 may identify first operation setting information based on the AI encoding information of the first electronic device 100, and identify second operation setting information based on the context information of the second electronic device 200. Then, the processor 230 may input the compression-released image into the second neural network model to which operation setting information having relatively lower processing performance is applied from among the first operation setting information and the second operation setting information.

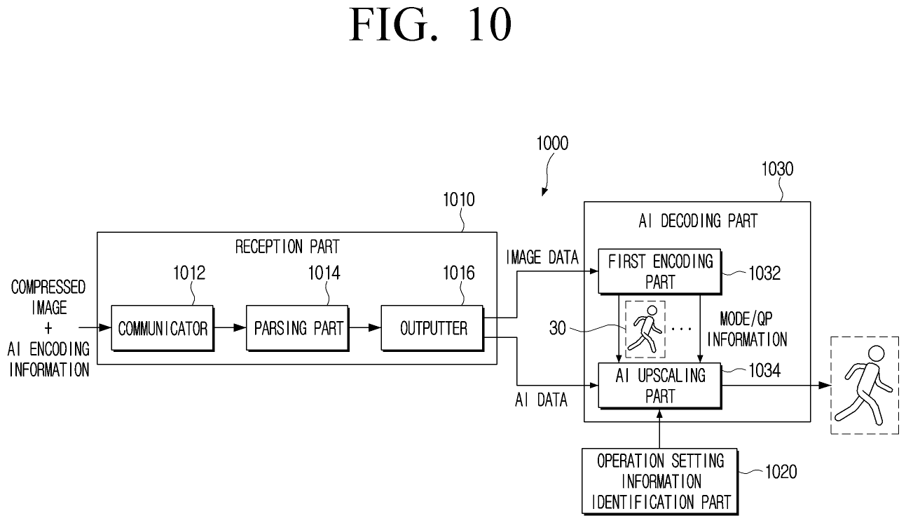

FIG. 10 is a diagram for illustrating an AI decoding method according to an embodiment of the disclosure.

According to an embodiment, the second electronic device 200 may be implemented as the AI decoding device 1000 illustrated in FIG. 10.

Referring to FIG. 10, the AI decoding device 1000 according to an embodiment may include a reception module 1010 and a decoding module 1030. The reception module 1010 may include a communicator 1012, a parsing module 1014, and an output module 1016. The decoding module 1030 may include a first decoding module 1032 and an AI upscaling module 1034.

The reception module 1010 distinguishes the image data and the AI encoding information from the received data, and outputs them to the decoding module 1030. The image data and the AI encoding information may be received through the same kind of network or different types of networks.

The parsing module 1014 receives the data received through the communicator 1012 and parses the data, and divides the data into the image data and the AI encoding information. For example, the parsing module 1014 may read the header of the data obtained from the communicator 1612, and distinguish whether the data is the image data or the AI encoding information. According to an embodiment, the parsing module 1014 distinguishes the image data and the AI encoding information through the header of the data received through the communicator 1012 and transmits them to the outputter 1016, and the outputter 1016 transmits each of the distinguished data to the first decoding module 1032 and the AI upscaling module 1034. Here, it may be identified that the image data is image data obtained through a predetermined codec (e.g., MPEG-2, H.264, MPEG-4, HEVC, VC-1, VP8, VP9, or AV1). In this case, in order that the image data can be processed with the identified codec, the parsing module 1014 may transmit the information to the first decoding module 1032 through the outputter 1016.

The first decoding module 1032 restores the second image 3000 (e.g., restored image 30) corresponding to the first image 2000 based on the image data. The second image 30 obtained by the first decoding module 1032 is provided to the AI upscaling module 1034. Depending on implementation examples, information related to the first decoding such as information on the prediction mode included in the image data, movement information, information related to a quantization parameter, etc. may be further provided to the AI upscaling module 1034.

The reception module 1010 and the decoding module 1030 according to an embodiment were explained as separate devices, but they may be implemented through one processor. In this case, the reception module 1010 and the decoding module 1030 may be implemented through a dedicated processor, or implemented through a combination of a generic-purpose processor such as an AP or a CPU, and a GPU and S/W. Also, in the case of a dedicated processor, it may be implemented to include memory for implementing the embodiments of the disclosure, or implemented to include a memory processing module for using external memory.

Also, the reception module 1010 and the decoding module 1030 may consist of a plurality of processors. In this case, the reception module 1010 and the decoding module 1030 may be implemented through a combination of dedicated processors, or implemented through a combination of a plurality of generic-purpose processors such as an AP or a CPU, and a GPU and S/W. Likewise, the AI upscaling module 1034 and the first decoding module 1032 may also be respectively implemented as different processors.

According to an embodiment, the upscaling target of the AI upscaling module 1034 may correspond to the downscaling target of the first DNN. Accordingly, the AI encoding information may include information that can identify the downscaling target of the first DNN. For example, the AI encoding information may include information on a difference between the resolution of the image 10 and the resolution of the first image 2000, and information related to the first image 2000. The difference information may be expressed as information on a degree of conversion of the resolution of the first image 2000 compared to the image 10 (e.g., information on a resolution conversion rate). Also, as the resolution of the first image 2000 can be identified through the resolution of the restored second image 3000 and the degree of conversion of the resolution can be identified through this, the difference information may be expressed only as the resolution information of the image 10. Here, the resolution information may be expressed as a screen size in horizontal/vertical directions, or expressed as a ratio (16:9, 4:3, etc.) and the size of one axis. Also, in case there is predetermined resolution information, the difference information may be expressed in a form of an index or a flag. The information related to the first image 2000 may include information on at least one of the bit rate of the image data obtained as a result of the first encoding of the first image 2000 or the type of the codec used in the first encoding of the first image 2000.

The operation setting information identification module 1020 may identify a plurality of DNN operation setting information that can be set in the second DNN based on the AI encoding information. The AI upscaling module 1034 performs AI upscaling of an image through the second DNN set with the DNN operation setting information identified in the operation setting information identification module 1020.

When an upscaling target is determined, the AI upscaling module 1034 performs AI upscaling of the second image 3000 through the second DNN for obtaining a third image 4000 (e.g., AI-decoded image 40) corresponding to the upscaling target. As the first DNN and the second DNN are trained in association, the AI encoding information includes information that enables correct AI upscaling of the second image 3000 through the second DNN to be performed. In an AI decoding process, the second image 3000 may be AI upscaled to a resolution and/or the image quality targeting the second image 3000 based on the AI encoding information.

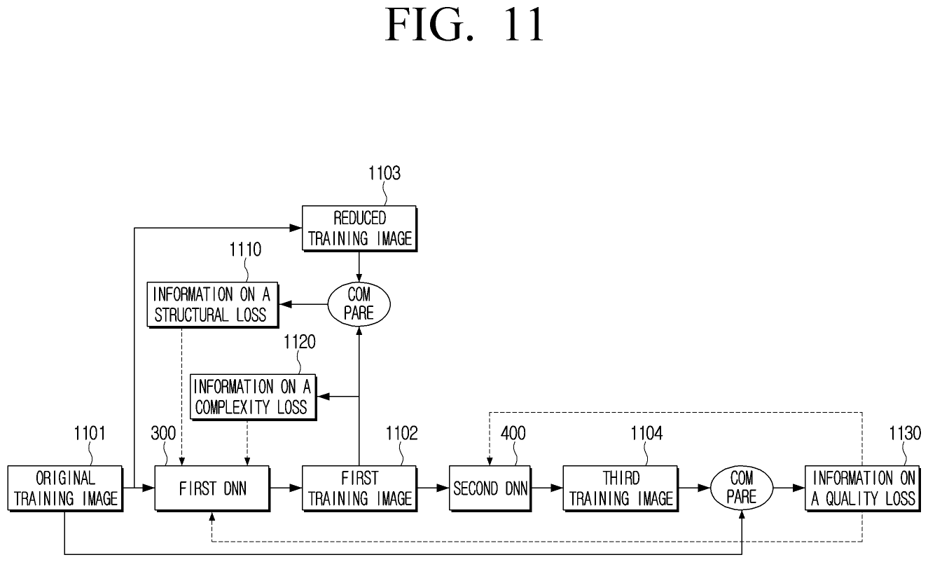

FIG. 11 is a diagram for illustrating a method of training a first neural network model and a second neural network model in association according to an embodiment of the disclosure.

According to an embodiment, an image 10 that was AI-encoded through an AI encoding process is restored to a third image 4000 through an AI decoding process, and in order that the similarity between the third image 4000 obtained as a result of the AI decoding and the image 10 can be maintained, relevance is needed in the AI encoding process and the AI decoding process. That is, the information that was lost in the AI encoding process should be restored in the AI decoding process, and for this, associative training of the first DNN 300 and the second DNN 400 is required. For correct AI decoding, it is ultimately necessary to reduce information on a quality loss 1130 corresponding to a result of comparison between the third training image 1104 and the original training image 1101 illustrated in FIG. 11. Accordingly, the information on the quality loss 1130 is used in all of the training of the first DNN 300 and the second DNN 400.

In FIG. 11, the original training image 1101 is an image which becomes a subject of AI downscaling, and the first training image 1102 is an image that was AI downscaled from the original training image 1101. Also, the third training image 1104 is an image that was AI upscaled from the first training image 1102.

The original training image 1101 includes a still image or a moving image consisting of a plurality of frames. According to an embodiment, the original training image 1101 may include a luminance image extracted from a still image or a moving image consisting of a plurality of frames. Also, according to an embodiment, the original training image 1101 may include a patch image extracted from a still image or a moving image consisting of a plurality of frames. In case the original training image 1101 consists of a plurality of frames, the first training image 1102, the second training image, and the third training image 1104 also consist of a plurality of frames. When the plurality of frames of the original training image 1101 are sequentially input into the first DNN 300, the plurality of frames of the first training image 1102, the second training image, and the third training image 1104 may be sequentially obtained through the first DNN 300 and the second DNN 400.

For associative training of the first DNN 300 and the second DNN 400, the original training image 1101 is input into the first DNN 300. The original training image 1101 input into the first DNN 300 is AI downscaled and output to the first training image 1102, and the first training image 1102 is input into the second DNN 400. As a result of the AI upscaling for the first training image 1102, the third training image 1104 is output.

Referring to FIG. 11, the first training image 1102 is being input into the second DNN 400, and depending on implementation examples, the second training image obtained through the first encoding and the first decoding processes of the first training image 1102 may be input into the second DNN 400. For inputting the second training image into the second DNN, any one codec among MPEG-2, H.264, MPEG-4, HEVC, VC-1, VP8, VP9, and AV1 may be used. Specifically, for the first encoding of the first training image 1102 and the first decoding of the image data corresponding to the first training image 1102, any one codec among MPEG-2, H.264, MPEG-4, HEVC, VC-1, VP8, VP9, and AV1 may be used.

Referring to FIG. 11, apart from the feature that the first training image 1102 is output through the first DNN 300, a reduced training image 803 that was legacy downscaled from the original training image 1101 is obtained. Here, the legacy downscaling may include at least one of bilinear scaling, bicubic scaling, lanczos scaling, or stair step scaling.

For preventing the structural feature of the first image 2000 from exceeding greatly based on the structural feature of the input image 10, the reduced training image 1103 keeping the structural feature of the original training image 1101 is obtained.

The first DNN 300 and the second DNN 400 before proceeding of training may be set with predetermined DNN operation setting information. As the training proceeds, information on a structural loss 1110, information on a complexity loss 1120, and information on a quality loss 1130 may be determined.

The information on the structural loss 1110 may be determined based on a result of comparison between the reduced training image 1103 and the first training image 1102. According to an embodiment, the information on the structural loss 1110 may correspond to a difference between the structural information of the reduced training image 1103 and the structural information of the first training image 1102. The structural information may include various features that can be extracted from the image such as the luminance, the contrast, the histogram, etc. of the image. The information on the structural loss 1110 indicates to which degree the structural information of the original training image 1101 is maintained in the first training image 1102. As the information on the structural loss 1110 is smaller, the structural information of the first training image 1102 becomes similar to the structural information of the original training image 1101.

The information on the complexity loss 1120 may be determined based on the spatial complexity of the first training image 1102. According to an embodiment, as the spatial complexity, the total variance value of the first training image 1102 may be used. The information on the complexity loss 1120 is related to the bit rate of the image data obtained by performing the first encoding of the first training image 1102. As the information on the complexity loss 1120 is smaller, it is defined that the bit rate of the image data is smaller.

The information on the quality loss 1130 may be determined based on a result of comparison between the original training image 1101 and the third training image 1104. The information on the quality loss 1130 may include at least one of an L1-norm value, an L2-norm value, a structural similarity (SSIM) value, a peak signal-to-noise ratio-human vision system (PSNR-HVS) value, a multiscale SSIM (MS-SSIM) value, a variance inflation factor (VIF) value, or a video multimethod assessment fusion (VMAF) value regarding a difference between the original training image 1101 and the third training image 1104. The information on the quality loss 1130 indicates to which degree the third training image 1104 is similar to the original training image 1101. As the information on the quality loss 1130 is smaller, the third training image 1104 becomes more similar to the original training image 1101.

Referring to FIG. 11, the information on the structural loss 11110, the information on the complexity loss 1120, and the information on the quality loss 1130 are used in the training of the first DNN 300, and the information on the quality loss 1130 is used in the training of the second DNN 400. That is, the information on the quality loss 1130 is used in all of the training of the first DNN 300 and the second DNN 400.

The first DNN 300 may update the parameters such that the information on the ultimate loss determined based on the information on the structural loss 1110, the information on the complexity loss 1120, and the information on the quality loss 1130 is reduced or minimized. Also, the second DNN 400 may update the parameters such that the information on the quality loss 1130 is reduced or minimized.

According to the aforementioned various embodiments, information on setting of an AI codec that can be supported by each terminal can be determined by identifying the performance and/or the states of the transmission terminal and the reception terminal, and information on setting of an AI codec that will be ultimately serviced can be determined by summing up the information of the two terminals. Accordingly, image quality that is optimal for the viewing environment can be provided, and the usability of the terminals can be improved.

Meanwhile, the methods according to the aforementioned various embodiments of the disclosure may be implemented in forms of applications that can be installed on conventional electronic devices. Alternatively, at least some of the methods according to the aforementioned various embodiments of the disclosure can be performed by using an artificial intelligence model based on deep learning, i.e., a learning network model.

Also, the methods according to the aforementioned various embodiment of the disclosure may be implemented just with software upgrade, or hardware upgrade for a conventional electronic device.

In addition, the aforementioned various embodiments of the disclosure may also be performed through an embedded server provided on an electronic device, or an external server of an electronic device.

Meanwhile, according to an embodiment of the disclosure, the aforementioned various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or by using other components under its control. An instruction may include a code that is generated or executed by a compiler or an interpreter. Also, a storage medium that is readable by machines may be provided in the form of a non-transitory storage medium. Here, the term ‘non-transitory’ only means that a storage medium does not include signals and is tangible, and the term does not distinguish a case wherein data is stored in the storage medium semi-permanently and a case wherein data is stored in the storage medium temporarily.

In addition, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

Further, each of the components (e.g.: a module or a program) according to the aforementioned various embodiments may include a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. In addition, operations performed by a module, a program, or other components according to the various embodiments may be executed sequentially, in parallel, repetitively, or heuristically. Or, at least some of the operations may be executed in a different order or omitted, or other operations may be added.

While preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic device configured for artificial intelligence (AI) encoding, the electronic device comprising:
memory storing a trained first neural network model;
a communication interface; and
at least one processor configured to:
obtain AI decoding information of an external device and context information of the electronic device;
identify operation setting information associated with AI encoding based on the AI decoding information of the external device and the context information of the electronic device;
input an image into a first neural network model to which the operation setting information is applied to obtain an AI-encoded image;
obtain a compressed image by encoding the AI-encoded image;
transmit the compressed image and AI encoding information associated with the first neural network model to the external device through the communication interface.

2. The electronic device of claim 1, further comprising:
a display,
wherein the context information of the electronic device comprises:
at least one of a performance information of the electronic device or a state information of the electronic device, and
wherein the performance information of the electronic device comprises:
at least one of information on an image size that can be processed, information on a scanning rate of the display, information on a number of pixels of the display, or information on a parameter of the first neural network model, and
wherein the state information of the electronic device comprises:
at least one of information on a ratio of a remaining power, information on a capacity of the remaining power, or information on available time, and
wherein the operation setting information associated with the AI encoding comprises:
at least one of information on a number of layers of the first neural network model, information on a number of channels for each layer of the first neural network model, information on a filter size of the first neural network model, information on stride of the first neural network model, information on pulling of the first neural network model, or the information on the parameter of the first neural network model.

3. The electronic device of claim 1,
wherein the AI decoding information of the external device comprises:
operation setting information associated with a second neural network model used in the AI decoding in the external device, and
the at least one processor is further configured to:
identify first operation setting information based on the AI decoding information of the external device,
identify second operation setting information based on the context information of the electronic device, and
input the image into the first neural network model to which operation setting information having relatively lower processing performance is applied from among the first operation setting information and the second operation setting information.

4. The electronic device of claim 3,
wherein the first neural network model is trained in association with the operation setting information associated with the second neural network model.

5. The electronic device of claim 1,
wherein the AI decoding information of the external device comprises:
operation setting information of a second neural network model used in the AI decoding in the external device, and
the at least one processor is further configured to:
identify the first neural network model to which first operation setting information is applied based on the AI decoding information of the external device,
identify the first neural network model to which second operation setting information is applied based on the context information of the electronic device, and
input the image into the first neural network model to which operation setting information having relatively lower processing performance is applied from among the first operation setting information and the second operation setting information.

6. The electronic device of claim 1,
wherein the at least one processor is further configured to:
identify priorities associated with a plurality of information included in the AI decoding information of the external device and the context information of the electronic device,
identify weights for each of the plurality of information based on the priorities, and
identify the operation setting information associated with the AI encoding based on the weights.

7. An electronic device configured for artificial intelligence (AI) decoding, the electronic device comprising:
memory storing a trained decoder neural network model;
a communication interface; and
at least one processor configured to:
receive a compressed image and AI encoding information through the communication interface,
identify operation setting information associated with AI decoding based on the AI encoding information,
obtain a reconstructed image by decoding the compressed image,
input the reconstructed image into a decoder neural network model to which the operation setting information associated with the AI decoding is applied to obtain an AI-decoded image, and
transmit AI decoding information related to the decoder neural network model to an external device.

8. The electronic device of claim 7,
wherein the operation setting information associated with the AI decoding comprises:
at least one of information on a number of layers of the decoder neural network model, information on a number of channels for each layer of the decoder neural network model, information on a filter size of the decoder neural network model, information on stride of the decoder neural network model, information on pulling of the decoder neural network model, or information on a parameter of the decoder neural network model.

9. The electronic device of claim 7,
wherein the at least one processor is further configured to:
identify priorities associated with a plurality of information included in the AI encoding information of the external device,
identify weights for each of the plurality of information based on the priorities, and
identify the operation setting information associated with the AI decoding based on the weights.

10. The electronic device of claim 7,
wherein the AI encoding information of the external device comprises:
operation setting information associated with the decoder neural network model used in the AI encoding in the external device, and
the at least one processor is further configured to:
identify first operation setting information based on the AI encoding information,
identify second operation setting information based on context information of the electronic device, and
input the reconstructed image into the decoder neural network model to which operation setting information having relatively lower processing performance is applied from among the first operation setting information and the second operation setting information.

11. A method for processing an image by using artificial intelligence (AI) encoding, the method comprising:
obtaining AI decoding information of an external device and context information of an electronic device;
identifying operation setting information associated with AI encoding based on the AI decoding information of the external device and the context information of the electronic device;
obtaining an AI-encoded image by inputting the image into a first neural network model to which the operation setting information associated with the AI encoding is applied;
obtaining a compressed image by encoding the AI-encoded image; and
transmitting the compressed image and AI encoding information associated with the first neural network model to the external device.

12. The method of claim 11,
wherein the context information of the electronic device comprises:
at least one of a performance information of the electronic device or a state information of the electronic device, and
wherein the performance information of the electronic device comprises:
at least one of information on an image size that can be processed, information on a scanning rate of a display, information on a number of pixels of the display, or information on a parameter of the first neural network model, and
wherein the state information of the electronic device comprises:
at least one of information on a ratio of a remaining power, information on a capacity of the remaining power, or information on available time, and
wherein the operation setting information associated with the AI encoding comprises:
at least one of information on a number of layers of the first neural network model, information on a number of channels for each layer of the first neural network model, information on a filter size of the first neural network model, information on stride of the first neural network model, information on pulling of the first neural network model, or the information on the parameter of the first neural network model.

13. The method of claim 11,
wherein the AI decoding information of the external device comprises:
operation setting information associated with a second neural network model used in the AI decoding in the external device, and
wherein the identifying the operation setting information associated with the AI encoding comprises:
identifying a first operation setting information based on the AI decoding information of the external device; and
identifying a second operation setting information based on the context information of the electronic device, and
wherein the inputting the image into the first neural network model comprises:
inputting the image into the first neural network model to which operation setting information having relatively lower processing performance is applied from among the first operation setting information and the second operation setting information.

14. The method of claim 13,
wherein the first neural network model is trained in association with the operation setting information associated with the second neural network model.

15. The method of claim 11,
wherein the AI decoding information of the external device comprises:
operation setting information of a second neural network model used in the AI decoding in the external device, and
wherein the identifying the operation setting information associated with the AI encoding comprises:
identifying the first neural network model to which first operation setting information is applied based on the AI decoding information of the external device; and
identifying the first neural network model to which second operation setting information is applied based on the context information of the electronic device, and
wherein the inputting the image into the first neural network model comprises:
inputting the image into the first neural network model to which operation setting information having relatively lower processing performance is applied from among the first operation setting information and the second operation setting information.

16. The electronic device of claim 11, wherein the identifying operation setting information associated with the AI encoding comprises:
identifying priorities regarding priorities associated with a plurality of information included in the AI decoding information of the external device and the context information of the electronic device,
identifying weights for each of the plurality of information based on the priorities, and
identifying the operation setting information related to associated with the AI encoding based on the identified weights.
